(19) United States
(12) Patent Application Publication
(10) Pub. No.: US 2026/0300800 A1
(43) Pub. Date: Oct. 1, 2026

(54) METHODS AND APPARATUSES FOR DETECTING ERRORS IN A QUANTUM CIRCUIT

(71) Applicant: IonQ, Inc., College Park, MD (US)

(72) Inventors: Min YE, Seattle, WA (US); Nicolas Guillaume DELFOSSE, Seattle, WA (US)

(21) Appl. No.: 19/575,650

(22) Filed: Mar. 23, 2026

Related U.S. Application Data
(60) Provisional application No. 63/777,529, filed on Mar. 25, 2025.

(51) Int. Cl. G06N 10/70; G06N 10/20

(52) U.S. Cl. CPC G06N 10/70; G06N 10/20

(57) ABSTRACT

Aspects of the present disclosure include a method and/or a system for detecting an error in a quantum circuit including initializing a plurality of trapped ions, associating the plurality of trapped ions with the plurality of physical qubits, associating a plurality of Pauli operators with the plurality of physical qubits, for each of the plurality of Pauli operators, iteratively perform the steps of: setting an ancilla qubit of a plurality of ancilla qubits to a state |0 [symbol] , applying a first Hadamard to the ancilla qubit, applying, in response to a corresponding Pauli operator being different than an identity gate, a controlled P-gate on the ancilla qubit to each of the plurality of physical qubits, and applying a second Hadamard gate to the ancilla qubit, measuring the plurality of ancilla qubits, and detecting one or more errors in the physical qubits in response to measuring the plurality of ancilla qubits.

### CROSS-REFERENCE TO RELATED APPLICATIONS

The current application claims priority to, and the benefit of, U.S. Provisional Application No. 63/777,529 entitled “METHODS AND APPARATUSES FOR DETECTING ERRORS IN A QUANTUM CIRCUIT” and filed Mar. 25, 2025, the contents of which are hereby incorporated by reference in their entireties.

### BACKGROUND

A quantum information processing (QIP) system may utilize trapped ions as qubits to perform computations. During computations in a QIP system, data in logical qubits may be encoded into physical qubits. After the encoding, the physical qubits may be used to perform quantum operations. However, due to the nature of operation of the physical qubits, errors may occur due to a variety of reasons. These errors may stem from the decoherence of one or more physical qubits. Therefore, it may be desirable to implement an effective error detection scheme to detect and/or correct errors in a quantum circuit.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure may include a method and/or a system for detecting an error in a quantum circuit including initializing a plurality of trapped ions, associating the plurality of trapped ions with the plurality of physical qubits, associating a plurality of Pauli operators with the plurality of physical qubits, for each of the plurality of Pauli operators, iteratively perform the steps of: setting an ancilla qubit of a plurality of ancilla qubits to a state |0 [symbol] , applying a first Hadamard to the ancilla qubit, applying, in response to a corresponding Pauli operator being different than an identity gate, a controlled P-gate on the ancilla qubit to each of the plurality of physical qubits, applying a second Hadamard gate to the ancilla qubit, measuring the plurality of ancilla qubits, and detecting one or more errors in the physical qubits in response to measuring the plurality of ancilla qubits.

Aspects of the present disclosure may include a method and/or a system for generating a BB5 code including generating a first matrix based on a first sum of a plurality of permutation matrices, each of the plurality of permutation matrices being constructed from a plurality of cyclic shift matrices, generating a second matrix based on a second sum of a plurality of transposed permutation matrices associated with the plurality of permutation matrices, identifying a combination of two or more of the plurality of cyclic shift matrices that yield a maximum code distance for the BB5 code, and encoding a plurality of physical qubits with a plurality of logical qubits with the BB5 code.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a QIP system according to aspects of the present disclosure.

FIG. 3 illustrates an example computer system or device in accordance with aspects of the disclosure.

FIG. 4 illustrates an example of a distance-5 surface code and the corresponding stabilizer generators in accordance with aspects of the disclosure.

FIG. 5 illustrates various examples of codes in accordance with aspects of the disclosure.

FIG. 6 illustrates an example of a syndrome extraction circuit in accordance with aspects of the disclosure.

FIG. 7 illustrates an example of a method for tuning a syndrome extraction circuit.

FIG. 8 illustrates examples of simulation results for BB5 codes, BB6 codes, and surface codes.

FIG. 9 illustrates an example of a method for detecting error in a quantum circuit in accordance with aspects of the disclosure.

FIG. 10 illustrates an example of a method for generating a BB5 code in accordance with aspects of the disclosure.

FIG. 11 illustrates another example of a QIP system including control subsystems in accordance with aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

A quantum information processing (QIP) system with quantum error correction (QEC) includes a first plurality of physical qubits and a second plurality of physical qubits, where the first plurality of physical qubits include data qubits, and the second plurality of physical qubits include ancilla qubits. Data qubits may be used for general quantum computing tasks or as quantum memory. Ancilla qubits may be used for detecting and correcting errors in the whole QIP system.

An example of Quantum Error Correction (QEC) operates by continuously repeating a three-step process. First, entanglement is established between the data qubits and ancilla qubits. Second, the state of the ancilla qubits is measured, typically determining if they are in the ground or an excited state. Third, the measurement results from the ancilla qubits reveal the presence and nature of errors in the quantum system. If errors are detected, this information guides the correction process. This cyclical process of entanglement, measurement, and correction actively eliminates errors in real-time, ensuring the integrity of the quantum computation.

A QEC scheme may include two key components: the QEC code and the corresponding syndrome measurement circuit (also known as a syndrome extraction circuit). The QEC code may dictate which pairs of data qubits and ancilla qubits become entangled during the above three-step process. The syndrome measurement circuit then may determine the specific order in which these entanglements are created.

Aspects of the present disclosure include a model for quantum computing with long chain of trapped ion (e.g., more than 50, 75, and/or 100 ions). Another aspect includes quantum error correction schemes tailored to this model. A syndrome extraction circuit may be adapted to the ion chain model and a syndrome extraction tuning protocol may be utilized to optimize this circuit. A high connectivity of ion chains may allow the reduction of ancilla qubits and/or the reduction of the qubit overhead.

In certain aspects, bivariate bicycle (BB) code family is a promising construction of quantum codes for fault-tolerant quantum computing. In a first aspect, surface codes with length up to 50 may be used. A BB code with optimal minimum distance for parameters [[n, k]]] with n≤50 may be implemented. A second aspect may include a variation of BB codes defined by weight-five measurements (from here on denoted as BB5 codes). The BB5 codes may achieve an improved minimum distance than traditional BB codes with the same parameters. Moreover, for a physical error rate of 10⁻³, the BB5 codes may achieve a logical error rate smaller than traditional BB codes (e.g., 3, 4, or 5 times smaller). In some aspects, the BB5 codes may achieve the same logical error rate as the distance-7 surface code but using 4× fewer physical qubits per logical qubit.

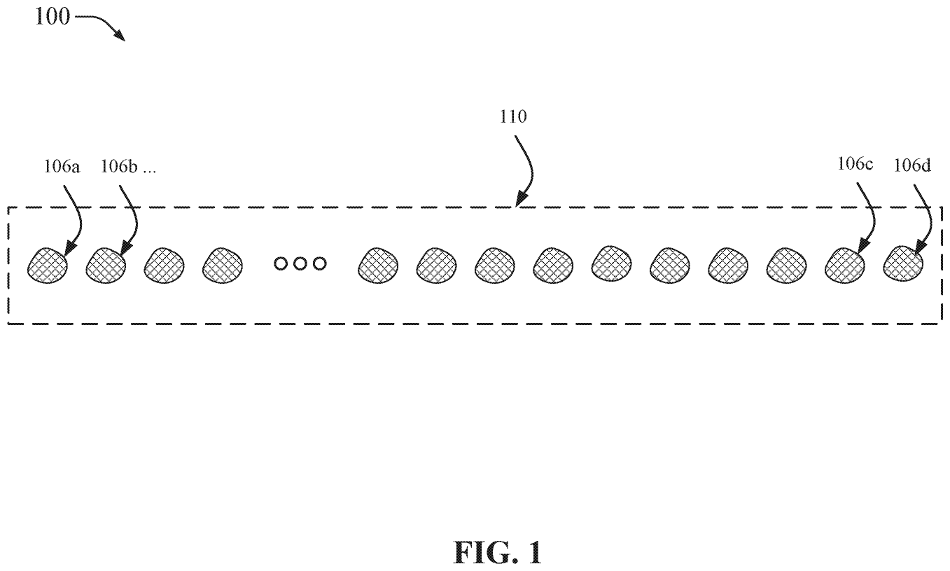

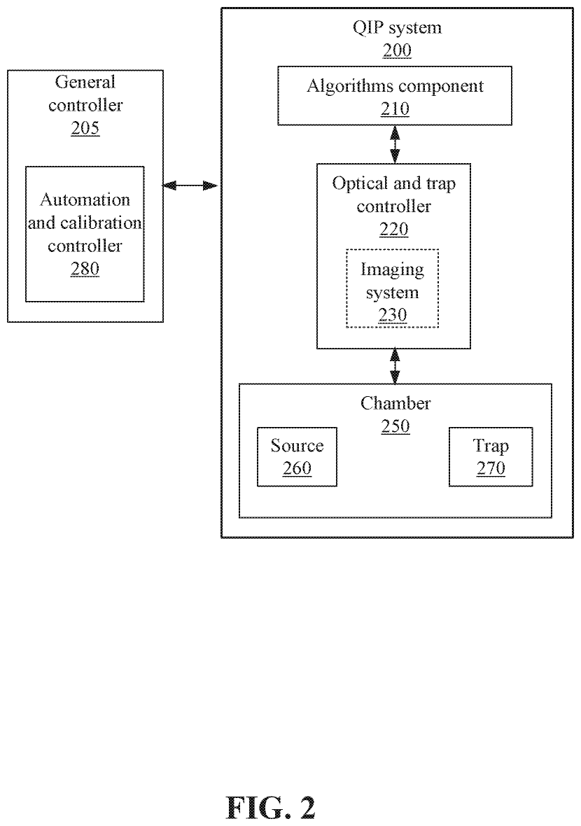

FIG. 1 shown below illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions can be Ytterbium ions (e.g., 171Yb+ ions), for example. The atomic ions are illuminated with laser (optical) radiation tuned to a resonance in 171Yb+ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used (such as one or more isotopes of barium, for example). The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 shown below is a block diagram that illustrates an example of a QIP system 200 in accordance with various aspects of this disclosure.

The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250. For example, optical systems within the chamber 250 may refer to optical components or optical assemblies.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, the optical and trap controller 220, and/or the imaging system 230.

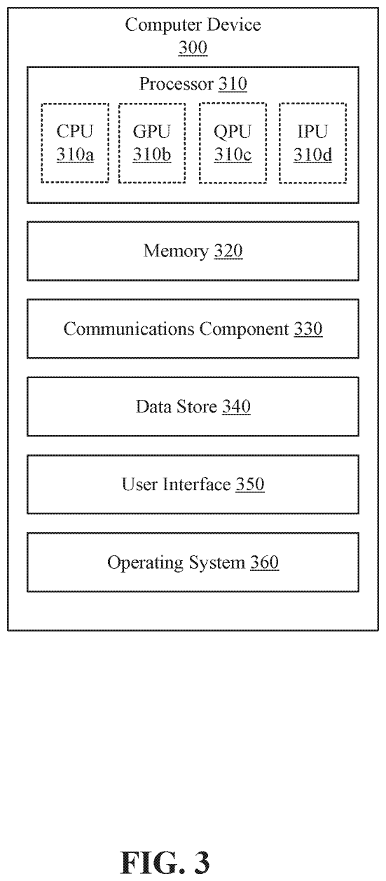

Referring now to FIG. 3 shown below, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In some aspects of the present disclosure, fault-tolerant quantum computing may rely on quantum error correction to correct faults that occurred during the computation the faults propagate to neighboring qubits. To benefit from quantum error correction, it may be important to design codes that are tailored to the specific constraints of the hardware. Surface codes and color codes, which are defined by local measurements on a lattice of qubits, may be suitable for superconducting chips. The codes may include a square grid of qubits with nearest neighbor connectivity. However, these quantum codes may require significant qubit overhead. In some cases, these quantum codes may require more than a thousand physical qubit per logical qubit.

Aspects of the present disclosure include designing quantum error correction codes for a long chain of trapped ions, such as the core module of a trapped ion quantum computer. An aspect is to design and optimize quantum error correction codes for ion chains with up to 50 qubits or more. Certain advantages of long ion chains include large coherence time and connectivity. Trapped ion technologies may achieve a gate error rate close to 10⁻³ for two-qubit gates and 10⁻⁴ for single-qubit gates. Further, qubits stored in a long ion chain may be fully connected, such that the native gate set may include entangling gates for each pair of qubits. This connectivity may indicate that trapped ions systems could be a good fit for the implementation of quantum low-density parity-check (LDPC) codes.

Aspects of the present disclosure include a model for quantum computing with a long ion chain, also known as the ion chain model. Certain properties associated with this technology may include one or more of (i) idle qubits have very long coherence time, (ii) two-qubit operations are noisier than single-qubit operations, which are noisier than idle qubits, (iii) qubits are fully connected, (iv) unitary gates are sequential (i.e., a single unitary gate may be implemented one at a time), (v) reset and measurement are parallel (i.e., reset or measure of any subset of qubits may be done in parallel), and/or (vi) measurements are slower than other operations.

A first aspect of the ion chain modeling including simulating surface codes that can be implemented with an ion chain with up to 50 qubits. A second aspect of the ion chain modeling include simulating a BB code with optimal minimum distance d for each possible parameters [[n, k]] achievable with this family with n≤50. Here, a [[n, k]] code encodes k logical qubits into n data qubits and the minimum distance d measures the error correction capability of the code. If dis known, the notation [[n, k, d]] may be used.

In one aspect of the present disclosure, quantum error correction may be implemented by executing a quantum circuit called the syndrome extraction circuit. The codes considered may be defined by a family of Pauli operators, its stabilizer generators, and/or the syndrome extraction circuit that implements the measurement of these operators. The connectivity of the ion chain model may offer increased flexibility in the design of the syndrome extraction circuit. To exploit this flexibility, a family of syndrome extraction circuits using a variable number of ancilla qubits may be implemented. An aspect of the present disclosure includes a syndrome extraction tuning protocol that optimizes these circuits to achieve a relevant tradeoff between logical error rate and qubit overhead.

An aspect of the present disclosure includes codes having parameters [[30, 4, 5]] and [[48, 4, 7]] and stabilizer weights 5.

An ion chain model according to aspects of the present disclosure relates to the connectivity, the parallelism, and/or the noise rate of quantum operations in a chain of trapped ions. The ion chain model, denoted Chain(n, p, τₘ), has three parameters: n for the number of qubits, p for the noise parameter, and τₘ that controls the measurement time. A register of qubits for this model is referred to as a n-qubit chain. The properties of the n-qubit chains are as follows.

A n-qubit chain is a register of n qubits equipped with the following operations: (i) prepare or reset any subset of qubits in the state |0 [symbol] , (ii) apply a single-qubit unitary gate to any qubit, (iii) apply a two-qubit unitary gate to any pair of qubits, (iv) measure any subset of qubits. The operations may be applied sequentially, i.e. one of these operations may be executed at a given time step.

The standard circuit level noise model in which each operation is associated with depolarizing noise. A two-qubit unitary gate is followed by a Pauli error with probability p. The error is selected uniformly among a number of Pauli errors (e.g., 15 Pauli errors) acting non-trivially on the support of the gate. A single-qubit operation (preparation, reset, and/or unitary gate) may be followed by a random Pauli error with probability p/10. The error may be X, Y or Z with probability ⅓ each. The outcome of a measurement may be flipped with probability p/10. An idle qubit may suffer from a random Pauli error with probability p/100 per gate time. Other numbers for the circuit level noise model may also be used according to various aspects of the present disclosure. Further, the operations may have substantially the same duration, except measurements that take τₘ times longer. An example of τₘ is 30. In some aspects, the qubits that remain idle during a measurement experience τₘ rounds of idle noise.

In certain aspects, the ions may be confined by an electromagnetic field that allows for a low atom loss rate. Each qubit may be stored within two energy levels of an ion. A n-qubit chain may contain more than n ions if additional ions are used for sympathetic cooling. The states of the qubits are changed by applying laser pulses without moving the ions. The operations entangling any of the

$$( \begin{matrix}n \\ 2\end{matrix} )$$

pairs of qubits may be available as native gates in the ion chain model. These operations may be implemented using the Mølmer-Sørensen scheme by illuminating the targeted ions using two laser beams. As such, an aspect of the present disclosure allows operating on a pair of distance qubits by controlling the laser beams without moving the ions. The operation may be mediated by the common vibrations of the ions.

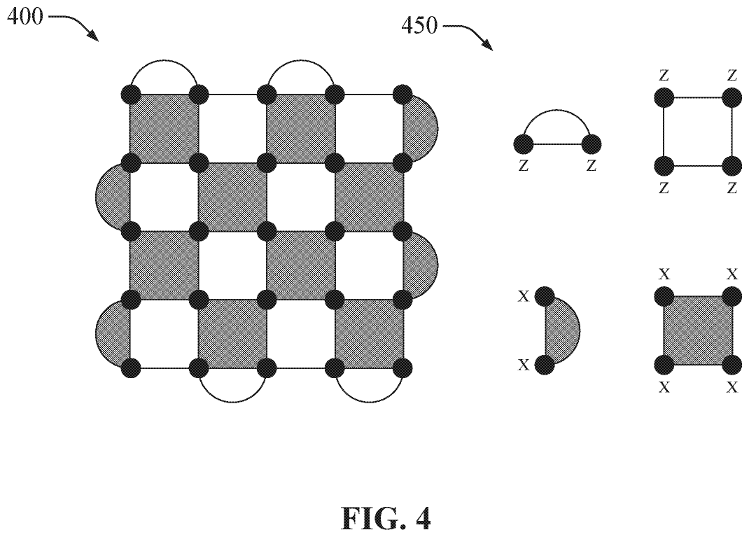

FIG. 4 illustrates an example of a distance-5 surface code 400 and corresponding stabilizer generators 450. The distance-5 surface code 400 may be a stabilizer code, which means the distance-5 surface code 400 is the common +1-eigenspace of a family of commuting Pauli operators called stabilizer generators. In general, the distance-d surface code is a [[d², 1, d]] stabilizer code defined on a d×d two-textured square tiling as shown in FIG. 4. Qubits are placed on the d² vertices and each tile may define a stabilizer generator acting on the four incident qubits either as X or Z depending on the tile texture. The stabilizer generators associated with boundary tiles act on two qubits only.

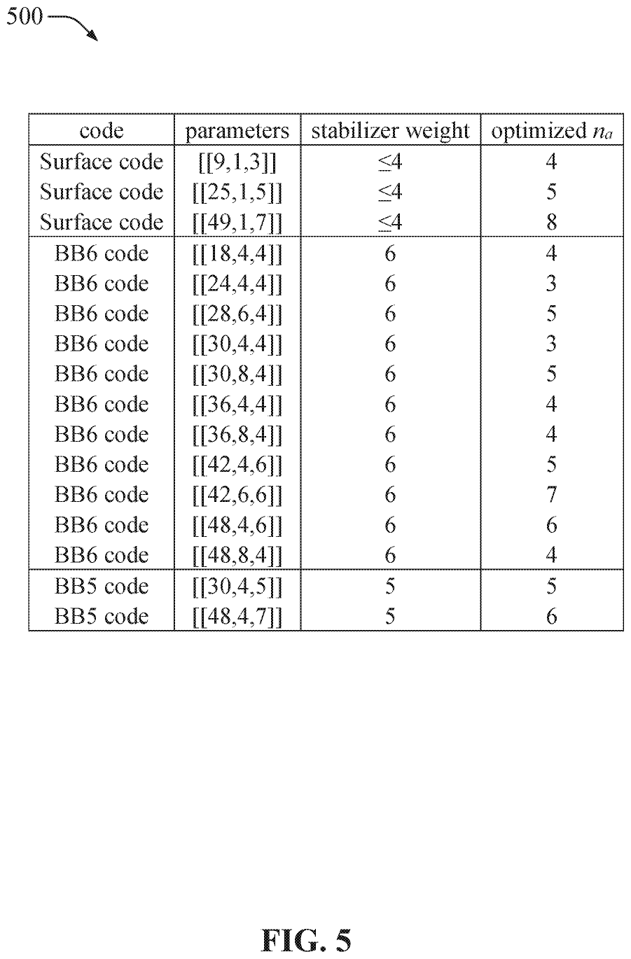

FIG. 5 illustrates a table 500 showing various examples of codes according to aspects of the present disclosure. The table 500 also shows parameters of the codes for up to 50 data qubits. Here, the optimized number of ancilla qubits nₐ is used for syndrome extraction described below.

Certain aspects of the present disclosure include BB codes. The BB codes are quantum LDPC codes. Here, [symbol] denotes the cyclic shift matrix of size [symbol] × [symbol] . More specifically, each row of [symbol] may be obtained from a cyclic right shift of the corresponding row in the identity matrix [symbol] . Define the matrices x= [symbol] ⊗Iₘ and [symbol] ⊗Qₘ where m and [symbol] are two positive integers. A BB code may be defined by the pair of matrices

$${H}_{X} = [ {A}_{1} + {A}_{2} + {A}_{3} \vert {A}_{4} + {A}_{5} + {A}_{6} ] ,$$

$${H}_{Z} = [ {A}_{4}^{T} + {A}_{5}^{T} + {A}_{6}^{T} \vert {A}_{1}^{T} + {A}_{2}^{T} + {A}_{3}^{T} ] ,$$

where every Aᵢ is a power of either x or y. Both H_{X} and H_{Z} have size (n/2)×n. The columns of these matrices correspond to the n=2 [symbol] data qubits of the code. Each row of H_{X} (respectively H_{Z}) is the indicator vector of a X (respectively Z) stabilizer of the code. Each row of H_{Z} is the indicator vector of a Z stabilizer of the code. By specifying m, [symbol] and the matrices A₁, A₂, . . . , A₆, a BB code instance may be defined. Given [symbol] and m, there are ( [symbol] +m)⁶ possible BB codes. Example parameters of some of the BB codes with length up to 50 with minimum distance of at least 3 are shown in the table 500.

The BB codes described above will be referred to as BB6 codes in the remainder of this application. The table 500 includes the BB5 codes (described below) and BB6 codes. The BB5 codes may achieve a reduced logical error rate per logical qubit.

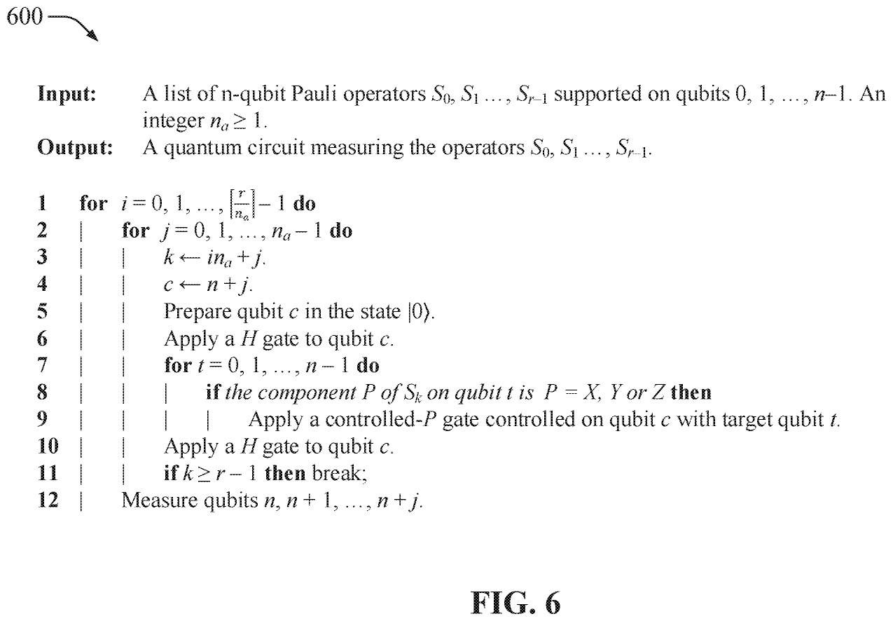

FIG. 6 illustrates an example of a syndrome extraction circuit 600 according to aspects of the present disclosure. In certain aspects of the present disclosure, the syndrome extraction circuit for a stabilizer code is the quantum circuit that performs the measurement of the stabilizer generators of the code. This circuit may be executed at regular interval to detect and/or correct errors. The ion chain model may offer flexibility when designing syndrome extraction circuits, which may be used to reduce the qubits overhead of quantum error correction codes.

In one aspect, a syndrome extraction circuit may be designed for a quantum code using a single ancilla qubit that is reused to measure the stabilizers generators. This scheme reduces the qubit overhead of the quantum code (e.g., surface and/or BB codes) by a factor almost 2. However, this may results in long waiting time and suboptimal logical error rate. To speed-up the syndrome extraction and/or to reduce the logical error rate, multiple ancilla qubits may be used that are measured contemporaneously. Aspects of the resent disclosure include a family of syndrome extraction circuit with a variable number of ancilla qubits. A further aspect of the present disclosure includes a protocol to select a number of ancilla qubits optimizing the tradeoff between the qubit overhead and the logical error rate.

An algorithm for an example of the syndrome extraction circuit 600 is shown in FIG. 6. Here, the syndrome extraction circuit 600 uses nₐ ancilla bits that are measured contemporaneously. The substantial parallelization of these measurements may yield a significant reduction of the total idle time of the qubits because the measurements consume operation times during the operations of a quantum circuit. Other gates may remain sequential.

In some aspects, to apply the syndrome extraction circuit 600 to a stabilizer code with r rounds of syndrome extraction, the input to the circuit 600 is the list of stabilizer generators of the code repeated r times. To estimate the performance of a stabilizer code with an ion chain syndrome extraction circuit, one aspect of the present disclosure includes using r=d rounds of syndrome extraction, where d may be the minimum distance of the code. The logical error rate per syndrome extraction round and per logical qubit may be estimated using a Monte Carlo simulation.

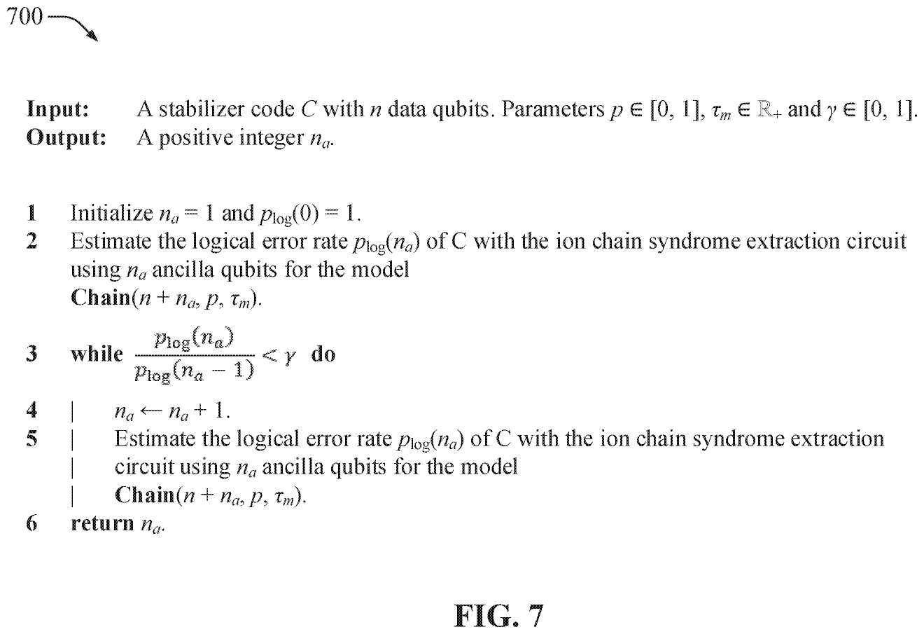

FIG. 7 illustrates an example of a method 700 for tuning a syndrome extraction circuit. In one aspect of the present disclosure, it may be desirable to optimize the syndrome extraction circuit by identifying a “sweet spot” between the number of ancilla qubits consumed and the logical error rate achieved. The protocol shown in FIG. 7 iteratively increases a number of nₐ ancilla bits as long as each iteration reduces the logical error rate by a factor γ. The value of optimized nₐ may depend on the quantum code, the measurement time τₘ, and/or the value of p. In one example, the values may be p=5·10⁻⁴ and τₘ=30. The factor γ=0.9 may be obtained by test, trial and error, or other experimental or empirical methods.

In some aspects, the number of nₐ ancilla bits may be implemented in for various syndrome extraction circuits, such as those shown in the table 500 of FIG. 5.

An aspect of the present disclosure includes a family of codes, termed BB5 codes. The BB5 codes may be defined by the pair of matrices:

$${H}_{X} = [ {A}_{1} + {A}_{2} \vert {A}_{3} + {A}_{4} + {A}_{5} ] ,$$

$${H}_{Z} = [ {A}_{3}^{T} + {A}_{4}^{T} + {A}_{5}^{T} \vert {A}_{1}^{T} + {A}_{2}^{T} ] .$$

Each Aᵢ is an ( [symbol] )×( [symbol] ) permutation matrix of the form

$${Q}_{ℓ}^{u} ⊗ {Q}_{m}^{v} ,$$

where [symbol] and Qₘ are cyclic shift matrices described above. The exponents u and v are chosen from the sets {0, 1, . . . , [symbol] −1} and {0, 1, . . . , m−1}, respectively. For a given code length n, the first step is to iterate through the possible pairs of [symbol] and m satisfying n=2 [symbol] . Then, for each pair, each possible combination of exponents u and v is examined before selecting the code that yields the largest code distance. Two examples of the BB5 code are shown below, and may be specified by the values of [symbol] , m and the matrices A₁, . . . , A₅.

$$\begin{matrix}\text{?} 30 , 4 , 5 \text{?} BB5 code : \\ ℓ = 5 , m = 3 , {A}_{1} = {A}_{3} = {I}_{15} , {A}_{2} = {Q}_{5} ⊗ {I}_{3} , {A}_{4} = {l}_{5} ⊗ {Q}_{3} , {A}_{5} = {Q}_{5}^{2} ⊗ {Q}_{3}^{2} .\end{matrix}$$

$$\begin{matrix}\text{?} 48 , 4 , 7 \text{?} BB5 code : \\ ℓ = 8 , m = 3 , {A}_{1} = {A}_{3} = {I}_{24} , {A}_{2} = {Q}_{8} ⊗ {I}_{3} , {A}_{4} = {I}_{8} ⊗ {Q}_{3} , {A}_{5} = {Q}_{8}^{3} ⊗ {Q}_{3}^{2} .\end{matrix}$$

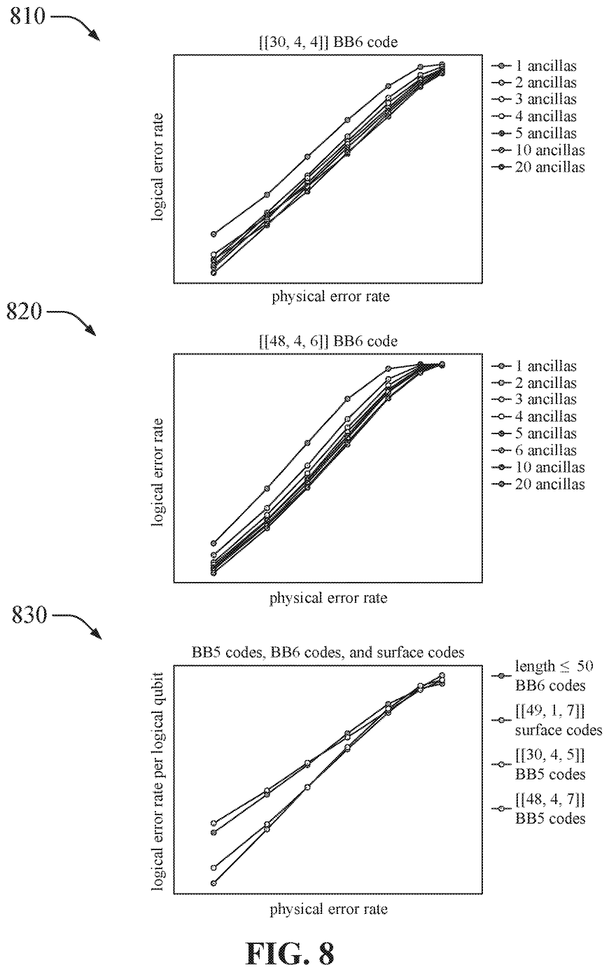

FIG. 8 illustrates examples of simulation results for BB5 codes, BB6 codes, and surface codes. A first graph 810 shows the simulation results for a [[30,4,4]] BB6 codes. A second graph 820 shows the simulation results for a [[48,4,6] BB6 codes. A third graph 830 shows the simulation results for BB5 codes, BB6 codes, and surface codes. To account for different number of logical qubits in different code instances, the logical error rate per logical qubit is plotted rather than the raw logical error rate. The logical error rate is defined as the sum of X- and Z-logical error rates, and the per-qubit rate is obtained from dividing this sum by the number of logical qubits. To estimate the X-logical error rate, the data qubits in the |+ [symbol] state may be initialized, and perform r rounds of syndrome extraction, where r equals the code distance. After r syndrome extraction cycles, the final measurements of all the data qubits are performed, and then decode for X-logical errors. The r-cycle X-logical error rate is then estimated as the ratio of decoding failures to the total number of simulations, and the X-logical error rate is this value further divided by r. The Z-logical error rate is estimated analogously, with data qubits initialized to |0 [symbol] and Z-logical error decoding performed after final measurements. Note that the initialization and final measurements of the data qubits may be subject to noise in the ion chain model.

In some aspects of the present disclosure, and referring to FIGS. 7 and 8, the method 700 for tuning the syndrome extraction circuit selects nₐ=3 ancillas for the [[30,4,4]] BB 6 code in the first graph 810 and nₐ=6 ancillas for the [[48,4,6]] BB6 code in the second graph 820. The data points accumulated at least 300 logical errors to estimate the logical error rate p, resulting in error bars≈p_{L}/\sqrt{300}<0.06·p_{L}.

In the third graph 830, each point on the blue curve represents the minimum achievable logical error rate per logical qubit for BB6 codes with code length less than or equal to 50. The data points accumulated at least 300 logical errors to estimate the logical error rate p_{L}, resulting in error bars≈p_{L}/\sqrt{300}<0.06·p_{L}. Including the ancilla qubits, the [[49,1,7]] surface code uses a total of 57 qubits and the [[48,4,7]] BB5 code uses a total of 54 qubits.

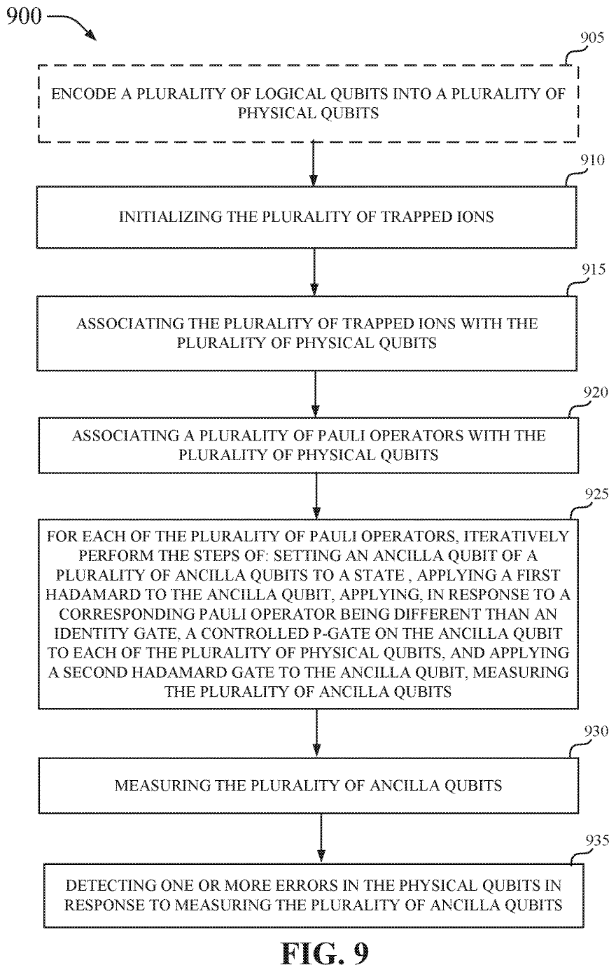

FIG. 9 illustrates an example of a method 900 for detecting error in a quantum circuit according to aspects of the present disclosure. The method 900 may be performed by one or more of the QIP system 200, the computer device 300, and/or one or more subcomponents of the QIP system 200 and/or the computer device 300.

At 905, the method 900 may optionally encode a plurality of logical qubits into a plurality of physical qubits. The method 900 may use one or more of the optical and trap controller 220, the general controller 205, the automation and calibration controller 280, the imaging system 230, the algorithm component 210, the trap 270, and/or the processor 310 to optionally encode a plurality of logical qubits into a plurality of physical qubits.

At 910, the method 900 may initialize a plurality of trapped ions. The method 900 may use one or more of the optical and trap controller 220, the general controller 205, the automation and calibration controller 280, the imaging system 230, the algorithm component 210, the trap 270, and/or the processor 310 to initialize a plurality of trapped ions.

At 915, the method 900 may associate the plurality of trapped ions with the plurality of physical qubits. The method 900 may use one or more of the optical and trap controller 220, the general controller 205, the automation and calibration controller 280, the imaging system 230, the algorithm component 210, the trap 270, and/or the processor 310 to associate the plurality of trapped ions with the plurality of physical qubits.

At 920, the method 900 may associate a plurality of Pauli operators with the plurality of physical qubits. The method 900 may use one or more of the optical and trap controller 220, the general controller 205, the automation and calibration controller 280, the imaging system 230, the algorithm component 210, the trap 270, and/or the processor 310 to associate a plurality of Pauli operators with the plurality of physical qubits.

At 925, the method 900 may, for each of the plurality of Pauli operators, iteratively perform the steps of: setting an ancilla qubit of a plurality of ancilla qubits to a state, applying a first Hadamard to the ancilla qubit, applying, in response to a corresponding Pauli operator being different than an identity gate, a controlled P-gate on the ancilla qubit to each of the plurality of physical qubits, and applying a second Hadamard gate to the ancilla qubit, measuring the plurality of ancilla qubits. The method 900 may use one or more of the optical and trap controller 220, the general controller 205, the automation and calibration controller 280, the imaging system 230, the algorithm component 210, the trap 270, and/or the processor 310 to, for each of the plurality of Pauli operators, iteratively perform the steps of: setting an ancilla qubit of a plurality of ancilla qubits to a state, applying a first Hadamard to the ancilla qubit, applying, in response to a corresponding Pauli operator being different than an identity gate, a controlled P-gate on the ancilla qubit to each of the plurality of physical qubits, and applying a second Hadamard gate to the ancilla qubit, measuring the plurality of ancilla qubits.

At 930, the method 900 may measure the plurality of ancilla qubits. The method 900 may use one or more of the optical and trap controller 220, the general controller 205, the automation and calibration controller 280, the imaging system 230, the algorithm component 210, the trap 270, and/or the processor 310 to measure the plurality of ancilla qubits.

At 935, the method 900 may detect one or more errors in the physical qubits in response to measuring the plurality of ancilla qubits. The method 900 may use one or more of the optical and trap controller 220, the general controller 205, the automation and calibration controller 280, the imaging system 230, the algorithm component 210, the trap 270, and/or the processor 310 to detect one or more errors in the physical qubits in response to measuring the plurality of ancilla qubits.

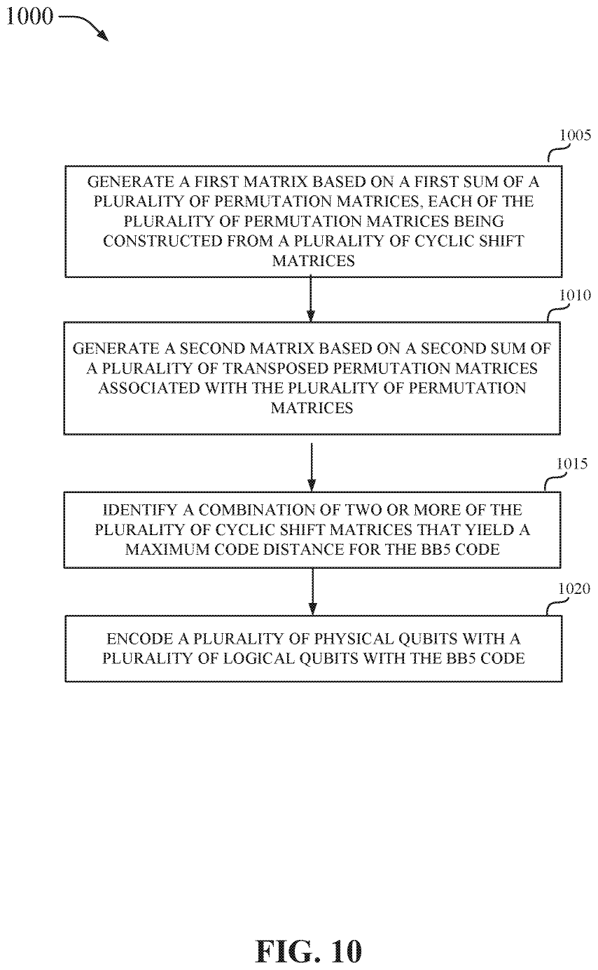

FIG. 10 illustrates an example of a method 1000 for generating a BB5 code according to aspects of the present disclosure. The method 1000 may be performed by one or more of the QIP system 200, the computer device 300, and/or one or more subcomponents of the QIP system 200 and/or the computer device 300.

At 1005, the method 1000 may generate a first matrix based on a first sum of a plurality of permutation matrices, each of the plurality of permutation matrices being constructed from a plurality of cyclic shift matrices. The method 1000 may use one or more of the optical and trap controller 220, the general controller 205, the automation and calibration controller 280, the imaging system 230, the algorithm component 210, the trap 270, and/or the processor 310 to generate a first matrix based on a first sum of a plurality of permutation matrices, each of the plurality of permutation matrices being constructed from a plurality of cyclic shift matrices.

At 1010, the method 1000 may generate a second matrix based on a second sum of a plurality of transposed permutation matrices associated with the plurality of permutation matrices. The method 1000 may use one or more of the optical and trap controller 220, the general controller 205, the automation and calibration controller 280, the imaging system 230, the algorithm component 210, the trap 270, and/or the processor 310 to generate a second matrix based on a second sum of a plurality of transposed permutation matrices associated with the plurality of permutation matrices.

At 1015, the method 1000 may identify a combination of two or more of the plurality of cyclic shift matrices that yield a maximum code distance for the BB5 code. The method 1000 may use one or more of the optical and trap controller 220, the general controller 205, the automation and calibration controller 280, the imaging system 230, the algorithm component 210, the trap 270, and/or the processor 310 to identify a combination of two or more of the plurality of cyclic shift matrices that yield a maximum code distance for the BB5 code.

At 1020, the method 1000 may encode a plurality of physical qubits with a plurality of logical qubits with the BB5 code. The method 1000 may use one or more of the optical and trap controller 220, the general controller 205, the automation and calibration controller 280, the imaging system 230, the algorithm component 210, the trap 270, and/or the processor 310 to encode a plurality of physical qubits with a plurality of logical qubits with the BB5 code.

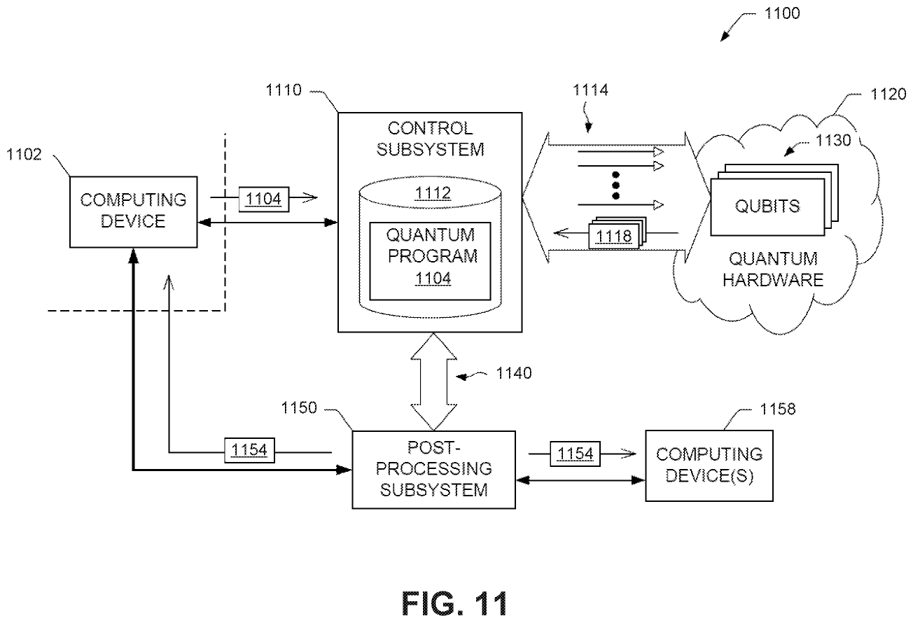

FIG. 11 illustrates an example of a QIP system in accordance with aspects of this disclosure. The example QIP system 1100 shown in FIG. 11 includes a control subsystem 1110 that can receive a quantum program 1104 from a computing device 1102 that can be remotely located relative to the example QIP system 1100 and is functionally coupled (e.g., communicatively coupled) to the control subsystem 1110. The computing device 1102 can send data defining the quantum program 1104 to control subsystem 1110 for execution in quantum hardware 1120, determining qubit placement in the quantum circuit and configuring quantum gates, as described herein. As is indicated by dashed lines, the computing device 1102 can be external to the example QIP system 1100. For example, the computing device 1102 can be a user device (e.g., a classical computer) of an end-user of the QIP system 1100. The control subsystem 1110 can retain the quantum program 1104 in one or more memory devices 1112. The quantum program 1104 corresponds to a defined quantum computation. The defined quantum computation can be an n-qubit computation, for example. The quantum program 1104 can include a quantum circuit (and, in some cases, sub-circuits) representing a quantum algorithm associated with quantum computation. Examples of the quantum algorithm include a variational quantum algorithm, a machine-learning algorithm, a Fourier transform algorithm, or the like.

The control subsystem 1110 can be functionally coupled to quantum hardware 1120 via multiple links 1114 that permits the exchange of data and/or controls signal between the control subsystem 1110 and the quantum hardware 1120. The quantum hardware 1120 can embody or can include one or more quantum computers. In some cases, the quantum hardware 1120 embodies a cloud-based quantum computer. In other cases, the quantum hardware 1120 embodies, or includes a local quantum computer. Regardless of its spatial footprint, the quantum hardware 1120 includes multiple qubits 1130 arranged in a particular layout. Each qubit of the qubits 1130 (e.g., computation and ancilla qubits) can be coupled to an environment and/or to one another. Such coupling(s) decoheres and relaxes quantum information contained in the qubit. Thus, the quantum hardware 1120 can be noisy. The type of multiple links can be based on the type of qubits 1130 used by the quantum hardware 1120 for computation. In some cases, the multiple links 1114 can include wireline links or optical links, or a combination of both.

As described herein, the qubits 1130 can include atomic qubits assembled in an atom-trap. Thus, the atomic qubits can be referred to as trapped-atom qubits. In some cases, each one of the atomic qubits can be a neutral atom. In other cases, each one of the atomic qubits can be an ion, such as an Ytterbium ion, a calcium ion, or similar ions. The atomic-qubits in such cases can be confined within an ion-trap (e.g., the trap 270 (FIG. 2) and can be assembled in a linear arrangement (such as the linear crystal or chain 110 (FIG. 1)). In other implementations, the qubits 1130 can include solid-state devices of one of several types. Such devices can be embodied in, for example, Josephson junction devices, semiconductor quantum-dots, or defects in a semiconductor material (such as vacancies in Si and Ge, or nitrogen-vacancy centers in diamond).

The control subsystem 1110 can cause the quantum hardware 1120 to execute the quantum circuit and/or sub-circuits as described herein. In response, the control subsystem 1110 can receive measurement data 1118 indicative of the outputs (e.g., tracked allowed output states and possible output states), for example. Because the quantum computation can be performed in two or more qubits, a measurement outcome can be represented as a bitstring representing a particular target output state given a particular set of qubits involved in a quantum computation. The control subsystem 1110 can supply at least a portion of the measurement data 1118 (e.g., ancilla qubit) to components of the control subsystem 1110 and/or other subsystems (e.g., post-processing subsystem 1150).

The control subsystem 1110 also can be functionally coupled to a post-processing subsystem 1150 via a communication architecture 1140. The communication architecture 1140 can include wirelines links, wireless links, network devices (such as gateway devices, servers, and the like), or a combination thereof. The post-processing subsystem 1150 can apply one or several post-processing techniques as described herein to measurements received from the quantum hardware 1120. By applying such techniques, the post-processing subsystem 1150 can generate a result 1154 of a quantum computation executed by the quantum hardware. The post-processing subsystem 1150 can send the result 1154 (or data indicative of the result 1154) to the computing device 1102 and/or other computing device(s) 1158. The post-processing subsystem 1150 also can cause the computing device 1102 to present the result 1154 in a particular way. For example, the post-processing subsystem 1150 can direct the computing device 1102 to present a user interface including the result 1154.

As described above with respect to FIGS. 1-3 and 11, in trapped-ion quantum computing systems, individual ions (e.g., in FIG. 1) are confined within an electromagnetic trap (e.g., typically a linear or segmented Paul trap) where radio-frequency (RF) and static (DC) electric fields provide radial and/or axial confinement. To shuttle ions between different functional zones of the trap (e.g., from a storage zone to a gate-operation zone or a measurement zone), the DC and/RF voltages applied to segmented control electrodes along the trap axis are dynamically adjusted. By varying the electric potential landscape in a coordinated fashion across multiple electrode segments, the potential well in which an ion resides can be translated along the axial direction, carrying the ion with it. The confinement and transport mechanism relies on electric fields and/or magnetic fields in ion-trap quantum computing architectures. In some aspects, magnetic field gradients (e.g., produced by current-carrying conductors integrated into or near the trap chip) can be employed to create position-dependent forces on the ions, providing a mechanism for ion transport.

Aspects of the present disclosure include a method of detecting errors in a quantum circuit including initializing a plurality of trapped ions, associating the plurality of trapped ions with a plurality of physical qubits, associating a plurality of Pauli operators with the plurality of physical qubits, for each of the plurality of Pauli operators, iteratively perform the steps of setting an ancilla qubit of a plurality of ancilla qubits to a state |0 [symbol] , applying a first Hadamard to the ancilla qubit, and applying, in response to a corresponding Pauli operator being different than an identity gate, a controlled P-gate on the ancilla qubit to each of the plurality of physical qubits, applying a second Hadamard gate to the ancilla qubit, measuring the plurality of ancilla qubits, and detecting one or more errors in the plurality of physical qubits in response to measuring the plurality of ancilla qubits.

Aspects of the present disclosure include the method above, further comprising calculating an error rate based on detecting one or more errors in the physical qubits.

Aspects of the present disclosure include any of the methods above, further comprising iteratively increasing a number of the plurality of ancilla qubits until a reduction in the error rate is less than a threshold value.

Aspects of the present disclosure include any of the methods above, wherein the plurality of physical qubits includes more than 50 physical qubits.

Aspects of the present disclosure include any of the methods above, wherein measuring the plurality of ancilla qubits comprises preserving quantum states of the plurality of physical qubits.

Aspects of the present disclosure include any of the methods above, further comprising implementing a bivariate code.

Aspects of the present disclosure include any of the methods and/or systems above. The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of detecting error in a quantum circuit, comprising:
initializing a plurality of trapped ions;
associating the plurality of trapped ions with a plurality of physical qubits;
associating a plurality of Pauli operators with the plurality of physical qubits;
for each of the plurality of Pauli operators, iteratively perform the steps of:
setting an ancilla qubit of a plurality of ancilla qubits to a state |0 [symbol] ,
applying a first Hadamard to the ancilla qubit,
applying, in response to a corresponding Pauli operator being different than an identity gate, a controlled P-gate on the ancilla qubit to each of the plurality of physical qubits, and
applying a second Hadamard gate to the ancilla qubit;
measuring the plurality of ancilla qubits; and
detecting one or more errors in the plurality of physical qubits in response to measuring the plurality of ancilla qubits.

2. The method of claim 1, further comprising calculating an error rate based on detecting one or more errors in the physical qubits.

3. The method of claim 2, further comprising iteratively increasing a number of the plurality of ancilla qubits until a reduction in the error rate is less than a threshold value.

4. The method of claim 1, wherein the plurality of physical qubits includes more than 50 physical qubits.

5. The method of claim 1, wherein measuring the plurality of ancilla qubits comprises preserving quantum states of the plurality of physical qubits.

6. The method of claim 1, further comprising implementing a bivariate code.

7. A non-transitory computer readable medium having instructions stored therein that, in response to one or more processors executing the instructions, cause the one or more processors of a quantum circuit to:
initialize a plurality of trapped ions;
associate the plurality of trapped ions with a plurality of physical qubits;
associate a plurality of Pauli operators with the plurality of physical qubits;
for each of the plurality of Pauli operators, iteratively perform the steps of:
set an ancilla qubit of a plurality of ancilla qubits to a state |0 [symbol] ,
apply a first Hadamard to the ancilla qubit,
apply, in response to a corresponding Pauli operator being different than an identity gate, a controlled P-gate on the ancilla qubit to each of the plurality of physical qubits, and
apply a second Hadamard gate to the ancilla qubit;
measure the plurality of ancilla qubits; and
detect one or more errors in the plurality of physical qubits in response to measuring the plurality of ancilla qubits.

8. The non-transitory computer readable medium of claim 7, further comprising instructions for calculating an error rate based on detecting one or more errors in the physical qubits.

9. The non-transitory computer readable medium of claim 8, further comprising instructions for iteratively increasing a number of the plurality of ancilla qubits until a reduction in the error rate is less than a threshold value.

10. The non-transitory computer readable medium of claim 7, wherein the plurality of physical qubits includes more than 50 physical qubits.

11. The non-transitory computer readable medium of claim 7, wherein the instructions for measuring the plurality of ancilla qubits comprises instructions for preserving quantum states of the plurality of physical qubits.

12. The non-transitory computer readable medium of claim 7, further comprising instructions for implementing a bivariate code.

13. A quantum information processing (QIP) system, comprising:
a plurality of trapped ions;
one or more memories storing instructions; and
one or more processors communicatively coupled with the one or more memories and configured to:
initialize the plurality of trapped ions;
associate the plurality of trapped ions with a plurality of physical qubits;
associate a plurality of Pauli operators with the plurality of physical qubits;
for each of the plurality of Pauli operators, iteratively perform the steps of:
set an ancilla qubit of a plurality of ancilla qubits to a state |0 [symbol] ,
apply a first Hadamard to the ancilla qubit,
apply, in response to a corresponding Pauli operator being different than an identity gate, a controlled P-gate on the ancilla qubit to each of the plurality of physical qubits, and
apply a second Hadamard gate to the ancilla qubit;
measure the plurality of ancilla qubits; and
detect one or more errors in the plurality of physical qubits in response to measuring the plurality of ancilla qubits.

14. The QIP system of claim 13, wherein the one or more processors are further configured to calculate an error rate based on detecting one or more errors in the physical qubits.

15. The QIP system of claim 14, wherein the one or more processors are further configured to iteratively increase a number of the plurality of ancilla qubits until a reduction in the error rate is less than a threshold value.

16. The QIP system of claim 13, wherein the plurality of physical qubits includes more than 50 physical qubits.

17. The QIP system of claim 13, wherein the one or more processors are further configured to preserve quantum states of the plurality of physical qubits.

18. The QIP system of claim 13, wherein the one or more processors are further configured to implement a bivariate code.
